(19) United States
(12) Patent Application Publication
(10) Pub. No.: US 2014/0368125 A1
(43) Pub. Date: Dec. 18, 2014

(54) LIGHTING PANEL WITH DISTRIBUTED CAPACITANCE

(71) Applicant: Q Technology, Inc., Livermore, CA (US)

(72) Inventor: Thomas E. Stack, Oxford, MI (US)

(73) Assignee: Q TECHNOLOGY, INC., Livermore, CA (US)

(21) Appl. No.: 14/300,223

(22) Filed: Jun. 9, 2014

Related U.S. Application Data
(60) Provisional application No. 61/832,904, filed on Jun. 9, 2013.

(51) Int. Cl. H05B 33/08

(52) U.S. Cl. CPC H05B 33/0821
USPC 315/251

(57) ABSTRACT

A system for capacitively transferring power to LEDs using intrinsic circuit board capacitance is disclosed. The plates of the capacitor are foil on either side of an insulating substrate. An AC source may deliver energy to a circuit, featuring an intrinsic circuit board capacitor in series with an LED.

### REFERENCE TO RELATED APPLICATIONS

This patent application claims the benefit of priority under 35 USC sections 119 and 120 of a provisional patent application filed Jun. 9, 2013 having Application Ser. No. 61/832,904. The entirety of the said U.S. provisional application 61/832,904, entitled “Lighting Panel With Distributed Capacitance”, is incorporated by reference herein.

### BACKGROUND

The present invention relates to lighting systems, and more particularly, to lighting systems with a plurality of LEDs or other light source elements.

There is an ongoing challenge to make the most of resources at hand to produce and maintain lighting systems. While the advent of LEDs made obsolete fluorescent lighting for at least some settings, it would be advantageous to still be able to use legacy fluorescent lighting ballasts even if not with fluorescent lamps.

Additionally there are cost pressures to reduce lighting circuit complexity and component count.

Still another lighting system challenge is to minimize radiated electrical noise.

Accordingly, there is a need for lighting assemblies and systems that reduce component count and electrical noise, while facilitating the re-use of ballasts intended for legacy fluorescent lighting systems.

### SUMMARY

The need present invention meets this need. In a first embodiment, a lighting module uses intrinsic circuit board capacitance to minimize wiring compared to conventional lighting panel wiring. This has several benefits. Reducing the metal foil removed from circuit boards saves resources, and so does reducing or eliminating the need for discrete capacitors (whether surface mount or through hole) to couple power.

Some embodiments will allow reuse of existing ballasts originally intended to drive fluorescent bulbs, to instead drive an LED lighting system. The new use of existing fluorescent ballasts will reduce scrap and disposal of ballasts even in settings where legacy fluorescent lighting is no longer used, while avoiding the need for custom power supply build-up.

However, where suitable legacy fluorescent ballasts are not available, circuits are described that will be suitable to drive the panel lighting system.

At least one embodiment has conductor arrangement to minimize EMI (Electro-Magnetic

Interference).

Other productive uses and advantages will be apparent from reading the following detailed description. The scope of the invention is indicated in the claims.

### BRIEF DESCRIPTION OF THE DRAWINGS

FIG. 1 is an electrical schematic of a prior art LED lighting system;

FIG. 2a is a generic block diagram of a generic LED lighting system, featuring an AC power source, impedance matching stage and LED circuit;

FIG. 2b is an electrical schematic of a specific implementation of FIG. 2a, with a coupling transformer for the impedance matching stage, and specific detail for a capacitively coupled LED lighting circuit;

FIG. 3 is an alternate representation of FIG. 2b, but with more detail regarding the output stage of the AC power source, and a physical implementation of an LED circuit using circuit board metallization and dielectric as a capacitive element;

FIG. 4a is a cross sectional view of a multilayer circuit board with LEDs mounted to it;

FIG. 4b shows a plan view of one surface of the circuit board in FIG. 4a;

FIG. 4c shows a plan view of the opposite side of the circuit board shown in FIG. 4b;

FIG. 5 shows one possible implementation of a circuit board metal foil pattern to provide distributed capacitance, as per dashed box 330 of FIG. 3, along with attached LEDs;

FIGS. 6a and 6b show two alternate perspectives of a built up LED circuit board assembly to be driven by an AC power supply, with point to point wiring between LEDs;

FIG. 7 show two alternate perspectives of another implementation of an LED circuit board assembly to be driven by an AC power supply, with wiring between LEDs using circuit board vias;

FIG. 8 shows a hypothetical, though industry representative prior art surface mount LED as a free-standing part, and;

FIGS. 9a and 9b show close up perspectives of LED conductor routing using a pad with through hole via.

### DETAILED DESCRIPTION

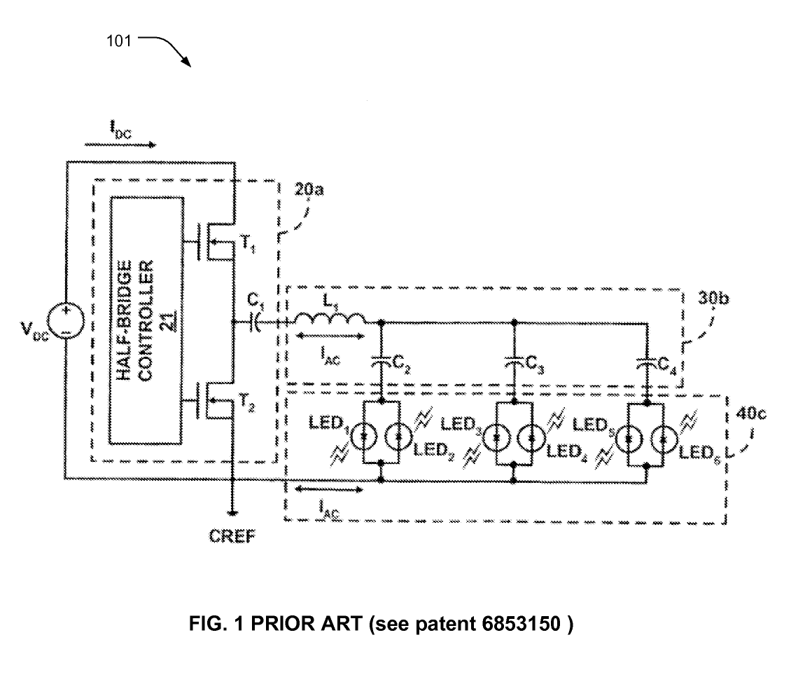

Referring now to FIG. 1, schematic 101 shows a previously known system for transferring electrical energy to LEDs, from U.S. Pat. No. 6,853,150.

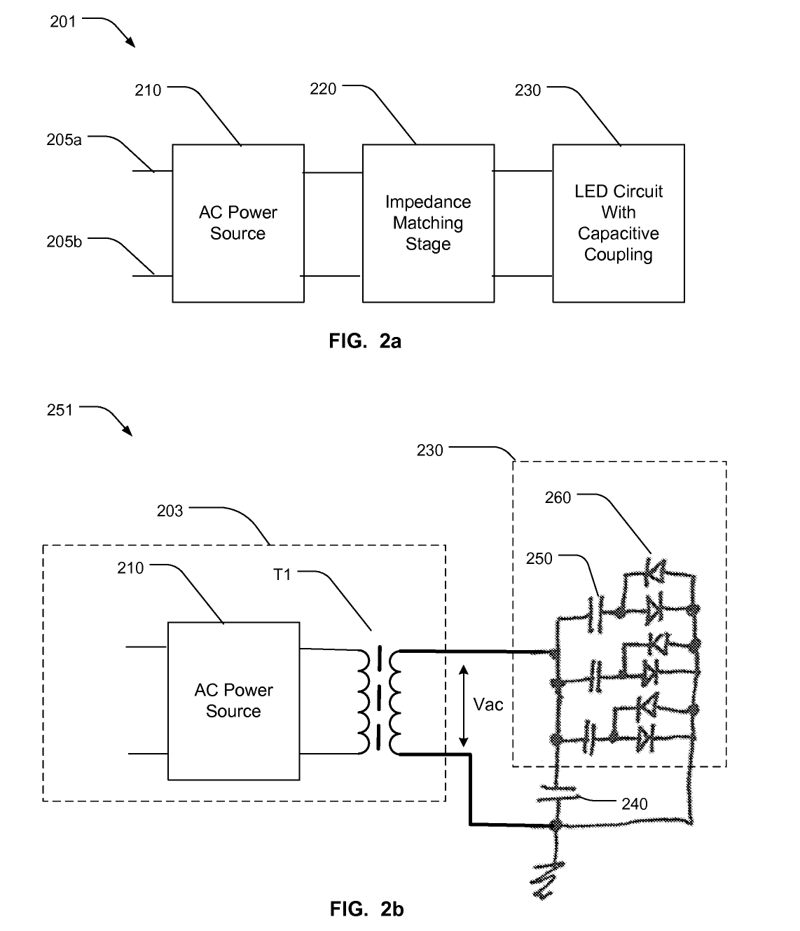

Referring now to FIG. 2a, a generic schematic 201 shows a power AC source 210 which drives power through impedance matching stage 220, to supply current to an LED circuit with capacitive coupling in box 230. The AC source 210 may be a ballast, or in combination with the impedance matching stage 220 may comprise a ballast. Also the AC source 210 may be a self-contained generator, or a circuit stage requiring electrical power input via lines 205a and 205b.

For this discussion, a ballast may be considered an AC power source with provision to regulate voltage and current delivery to a load. Known examples suitable for this purpose include the Royer and IR2151 type drive circuits. A Royer type oscillator is exemplified in U.S. Pat. No. 7,405,522, which is also owned by the applicant and incorporated by reference.

Application notes with sample schematics using the type IR2151 integrated circuit are available from International Rectifier. The IR2151 is a self-oscillating half-bridge driver and may be used to implement at least part of the function of block 20a on the schematic 101, without undue experimentation.

Referring still to FIG. 2a, other types of power sources 210 are also acceptable for this application.

For the load side 230, capacitors are known to be useful as current limiting elements in AC LED circuits, and have the advantage of dissipating minimal electrical power compared to current limiting resistors.

Referring now to FIG. 2b, a more particular schematic 251 shows an AC power source 210 along with a transformer T1 contained within dashed box 203. This source 210 drives power through transformer T1, to supply current to a set of light emitting diodes and capacitors in dashed box 230. To allow conduction on both polarities of the AC waveform, in this example separate LEDs 260 are connected alternately, that is anti parallel, in both forward and reverse directions.

T1 may optionally have one or more additional secondary windings (not shown). Some reasons for having additional windings may include phase feedback to maintain tuning, or circuit state of health monitoring.

To optimize power transfer from the AC power source 210, a trim capacitance 240 may be placed in parallel with the load feed and return points to help tune the coupling between load 230 and AC source with coupling transformer in dashed box 203. Depending on the type of oscillator used as an AC source 210, this capacitor 240 may also affect the oscillation frequency.

A Royer oscillator (push-pull resonant oscillator with positive feedback from a secondary winding) is preferred for use as a ballast 203 comprising AC power source 210 and coupling stage T1 because of its simplicity, stable output frequency, power level, and substantially sinusoidal output.

An advantage of the Royer oscillator is its behavior to act essentially as a constant current source. Consequently, with a Royer oscillator supply feeding a parallel LED string load configuration, if some LED strings drop out, the rest will get more current, substantially making the brightness constant. However, there may be some limits to this balancing effect in that some LEDs are less efficient at higher current.

Other AC oscillator types may acceptably provide power to the load circuit 230, as long as they have the desired frequency and power level.

Another consideration for ballast oscillator choice is optionally to minimize EMI (Electro Magnetic Interference). The EMI noise level should be controllable by sustaining a low frequency RF oscillation, for example at 20 kHz. Also to minimize EMI, the drive circuit should preferably have substantially sinusoidal output. Amplifier and wave shaping capabilities are available in the art to produce an AC drive excitation with sufficient power level to light LEDs and minimal harmonic content to stay within the guidelines of the FCC and other regulatory agencies. Again, a low frequency RF AC source 210 with minimal harmonic content, that is substantially sinusoidal wave shape, will minimize possible EMI issues.

In use with an AC ballast supplying current to a solid-state lighting design, another benefit of low frequency RF operation is to reduce risk of harm to personnel. In studies of electrical safety and shock hazard, 20 kHz current is less of a personnel risk than 60 Hz current, for example.

In FIG. 2b load stage 230, the current limiting capacitors 250 may be discrete components (for example surface mount or through hole components), as is typical in the art. However it is also possible to use parasitic or intrinsic capacitors formed by foil pads on a circuit board.

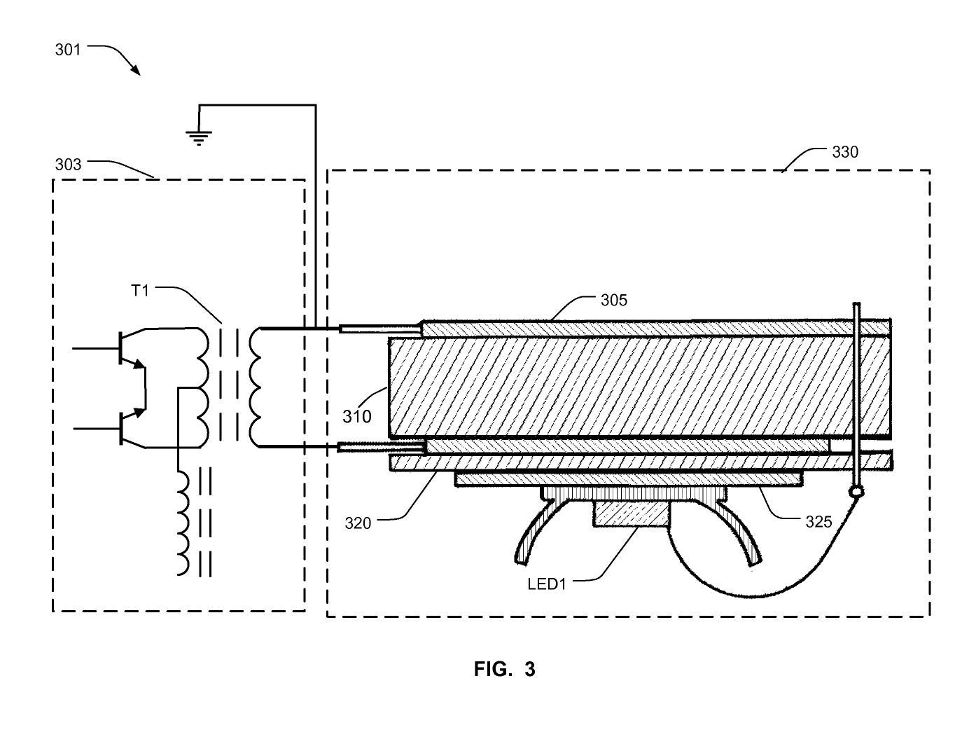

Referring now to FIG. 3, a representative physical implementation of FIG. 2b load stage 230 is shown in cross section within dashed box 330 containing an LED lighting panel. Dashed box 330 contains a multilayer printed circuit board (PCB) with a common electrical plate 305 formed by the extended foil on one side of the PCB. On the other side of the PCB dielectric layer 320, an example capacitor metallization plate 325 comprises a capacitor together with said dielectric layer 320 and common electrical plate 305. The reason this is a representative implementation is that just one LED chip, LED1, is shown, whereas one or more LED chips may be present with respective, separate foil areas comprising individual capacitors.

In schematic form dashed box 303 shows electrical details of the output stage of an AC power supply. The power transfer goes from the push-pull or half-bridge RF exciter through transformer Ti to the circuit board shown as a mechanical construct in dashed box 330. Again, other AC supply sources may be used to supply load 330. In this diagram for illustration purposes, the dashed box 330 shows only one LED, while multiple LEDs and intrinsic capacitors could be present in a preferred implementation.

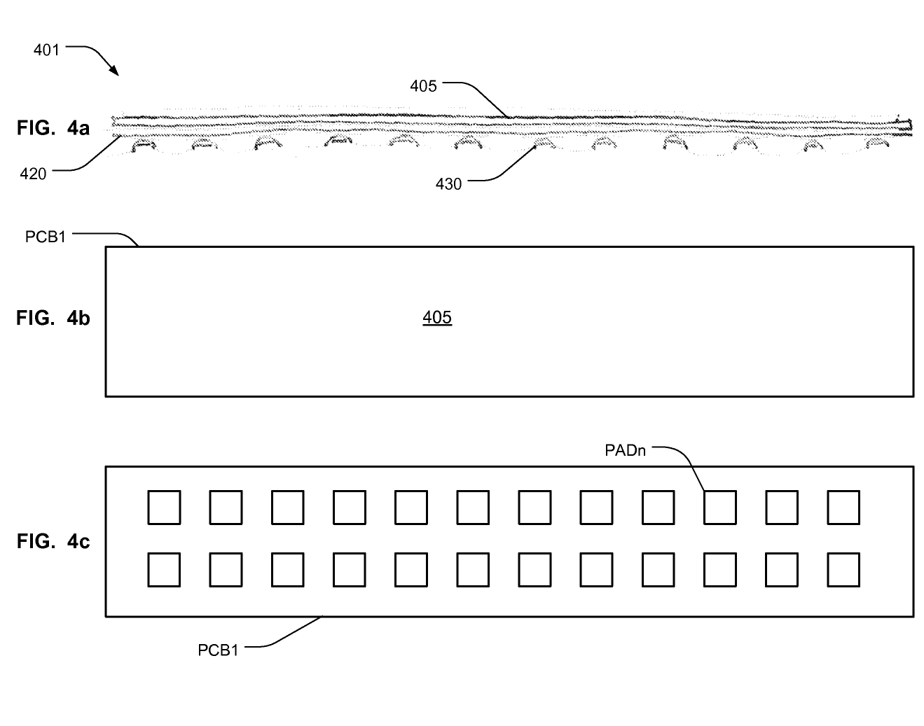

Referring now to FIG. 4, construction details building up from circuit board 401 with intrinsic capacitance are visible. In FIG. 4a, a cross section shows common electrical plate 405, dielectric 420, and reflectors 430 that are affixed to pads on the side of dielectric 420 opposite to electrical plate 405. The dielectric 420 serves both as the insulator and dielectric material for a capacitor, and as a substrate for mechanical support of electrical and possibly other parts.

FIGS. 4b and 4c show merely the circuit board PCB1 without reflectors, LEDs, or other items attached. In selecting the substrate, a material with low damping losses at RF frequencies is preferable. FR4 grade glass-reinforced epoxy laminate printed circuit board material, which is known in the art, is suitable for this purpose. PCB1 is understood to comprise substrate 420, as well as foil plating on surfaces 405 on one side, shown in FIG. 4b and PAD1 through PADn on the opposite side, shown in FIG. 4c.

As shown in FIG. 4b, the common electrical plate 405 may occupy the entire area of one side of circuit board 401, though could have smaller overall area than the dielectric substrate 420. As shown in FIG. 4c, foil patterns on the side of dielectric 420 opposing common electrical plate 405 may be produced through etching or other removal from contiguous foil so as to form pads PAD1 through PADn. Alternatively, pads may be formed individually through a metal deposition process to an uncoated substrate. These opposing pads PAD1 through PADn, along with the substrate/dielectric 420, form intrinsic capacitors in conjunction with the common plate 405. The number and pattern of pads PAD 1 through PADn in this illustration is merely for example.

In later construction steps, LEDs may be soldered to the pads, and reflectors 430 attached as in FIG. 4a.

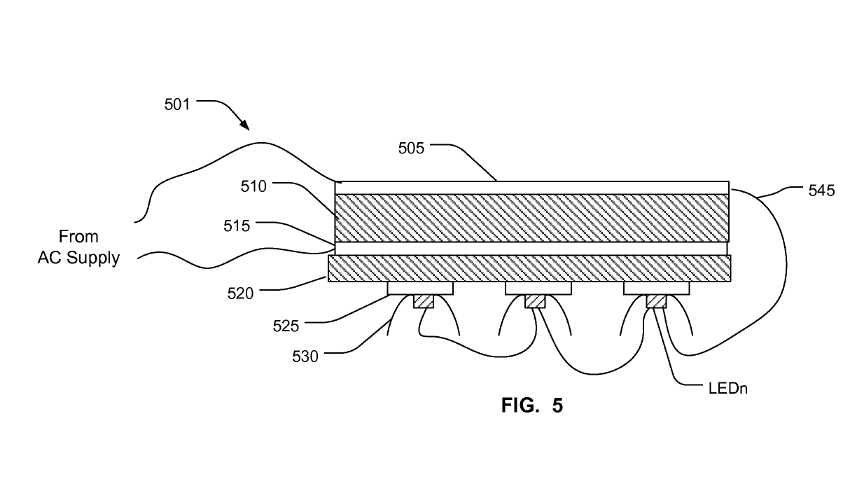

FIG. 5 shows a more complete and detailed version of the lighting assembly shown in dashed box 305 of FIG. 3, with LEDs in place. The LEDs shown are of simplified and hypothetical construction, with one electrical contact arranged to be matched with the foil pad 525 and the other contact, here shown on the opposite side, to be matched with a wire string 545. The point is that construction is possible with single-chip LEDs that have contacts at arbitrary points. It is known in the art how to make electrical contact with LEDs even when their connector pins emerge at arbitrary angles. The contact points as shown are for convenience of illustration.

The LED wiring 545 may be routed more closely to the circuit board layer 520 but is shown at some distance, also for clarity. In practice, the wiring 545 which is shown placed at a distance from circuit board 520 for exemplary purposes, would be placed as close as possible to minimize wiring distance while maintaining boundaries to insulate from neighboring circuitry. Additionally, it would even be possible to route wiring through holes cut or formed in reflectors 530 to facilitate direct routing.

Referring to FIG. 3 and more particularly to FIG. 5, each LED is current limited by an intrinsic capacitor comprised of its corresponding pad, for example 525, and the opposing foil side 515 of circuit board 501. Each intrinsic capacitor manifests, for example, from the proximity of metal foil elements 515 and 525 separated by the dielectric layer 520 in between. If needed, the effective working capacitance value may be calculated based on the area of pad 525 and thickness and dielectric constant of substrate material 520.

An insulating layer 510, which may also be made of FR4, allows routing a conductor 505 on the upper portion of assembly 501. To safely isolate AC voltage across the panel, the insulation layer 510 may be used to separate the AC voltage feed side foil 515 from the return foil side 505. The intrinsic capacitance made between foils 505 and 515 may serve a tuning purpose analogous with capacitor 240 in FIG. 2b.

The wire 545 connecting to the conductor 505 may be wrapped around to the lower side of assembly 501 for connecting to one or more LEDs. If conductor 515 is fed with the “hot” side of the energy from the RF exciter, where it is surrounded on either side by insulating layers 510 and 520, this routing and isolation arrangement would reduce electrical shock hazard in the vicinity of the circuit while it is running.

To further reduce shock risk, a wire may optionally be connected between conductor 505 and building ground. The presence and routing of this optional wire, not shown, may also help to control electro magnetic interference. Methods of ground wiring to reduce electromagnetic interference are well known in the art.

Viewing the optics of FIG. 5, each LED chip is surrounded by an optional reflector 530, configured and positioned to direct light emission, with each LED and corresponding reflector 530 working in cooperation.

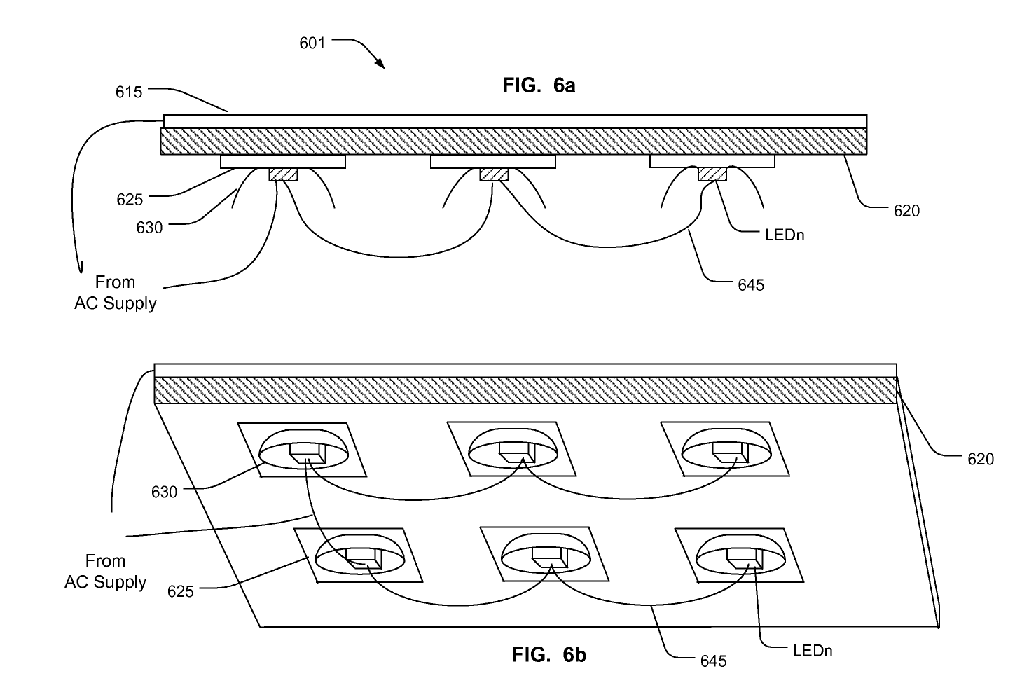

FIGS. 6a and 6b represent yet another possible lighting panel implementation featuring LEDs, reflectors, and intrinsic coupling capacitance manifested between, for example, a foil pad 625 and the foil plate 615. In this example the LEDs are electrically connected as one or more series strings using jumper wires 645. Corresponding to FIG. 5, the dielectric of the capacitor is

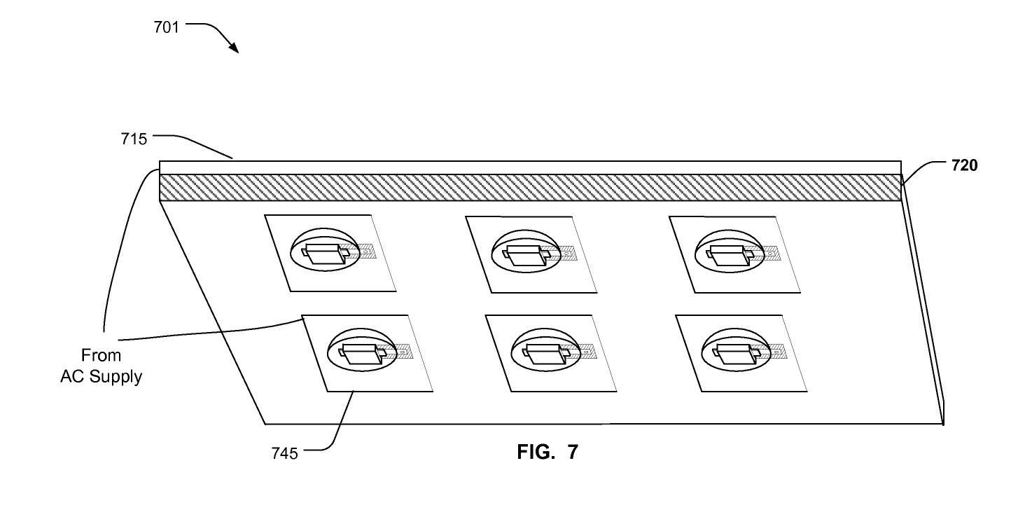

FIG. 7 shows yet another possible lighting panel implementation featuring LEDs, reflectors, and intrinsic coupling capacitance comprised of the interaction between plate 715, dielectric 720, and pads 745. From a design and construction standpoint, when using SMD (Surface Mount Device) LEDs, electrical connections from one side of the PCB coupling through the PCB need not necessarily be completed with wire, but could be made with solder plated and metal filled holes known in the industry as vias. This would further simplify construction by totally automated means. This may require an extra layer of circuit board to keep separate the “hot” side of the applied AC from the “ground” side.

Additionally, the vias need not be only for connecting directly to LEDs, but also may serve a purpose of allowing circuit pathways to avoid the use of jumper wires. It is also possible to use a mixed strategy, of using vias for some routing purposes and jumper wires for others.

The LEDs may be of discrete chip version, which may be directly affixed to the circuit board and then covered with an optically transmissive coating, or already encapsulated into a light transmissive package for placement on the circuit board.

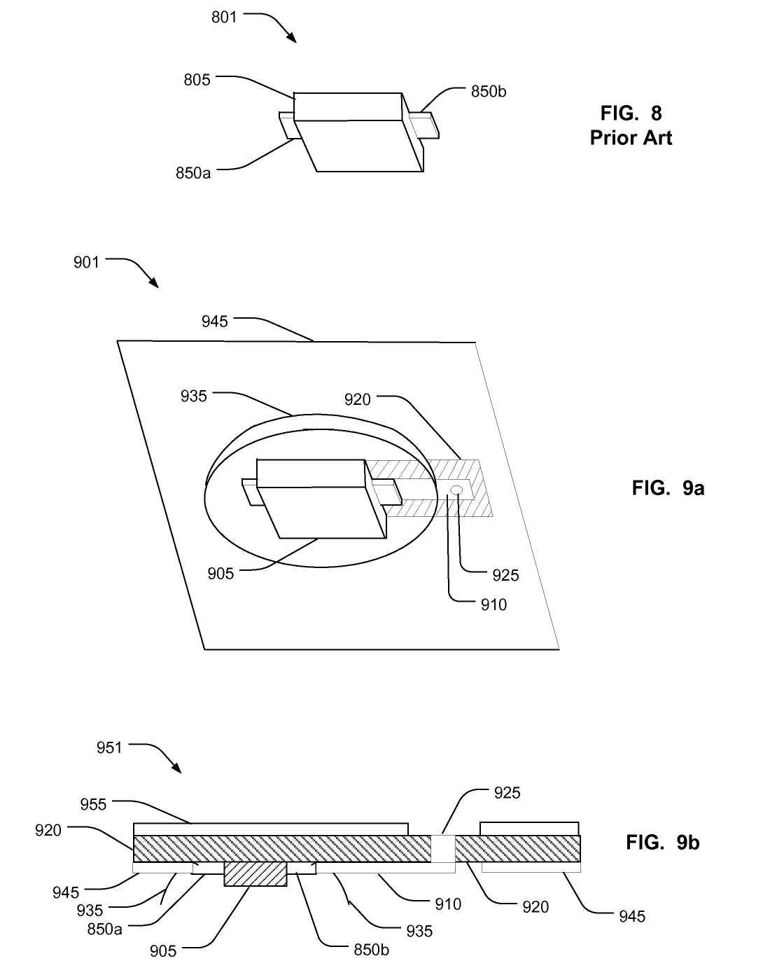

FIG. 8 shows a simplified portrayal of an SMD LED that is free standing, not connected to anything due to being fresh off the production line, and is therefore labeled Prior Art. As is standard in the art, the body 805 of the SMD LED contains at least one light emitting diode, encased in an impervious light transmitting material. The metal leads 850a and 850b allow electrical supply to the LED, and provide points for solder attachment to a circuit board. It should be noted that a stand-alone SMD LED package may contain one or more light emitting diodes of the same polarity, or a plurality of diodes arranged in opposite polarity.

FIG. 9a shows a close up perspective view of a built up circuit board section 901 with an SMD LED 905 and via 925 to connect the LED 905 to at least one other circuit element. The via 925 is shown as an extension of circuit board trace 910. The surface of the circuit board with foil etched away is shown as hatched area 920. Nonconductive area 920 electrically isolates foil area 910 from foil area 945. Optional reflector 935 is shown surrounding LED 905 and may be affixed to the circuit board with methods known in the art.

FIG. 9b shows a cross sectional view of a circuit board 951 having a pad 945 as in FIG. 9a. Here, via 925 is used to connect a trace or plate 910 from one side of the circuit board substrate 920 to the other.

### CONCLUSIONS, RAMIFICATIONS, AND SCOPE

Though a ballast intended for fluorescent lighting may energize the LED circuit, that is by no means required and it is possible to achieve desired results with a custom built ballast specifically for powering the LED circuitry.

Various connecting means are known in the art to connect LEDs on a circuit board and use of the examples disclosed here should not be construed as limiting to any particular type of connection.

Though a foil on substrate is recommended as the preferred way to implement the capacitive part of the invention, it would also be practical to achieve the desired behavior of the invention by way of thicker or differently shaped conductors for the capacitive plates, or a dielectric other than a solid substrate, whether vacuum, gas, or liquid.

It should also be emphasized that planar panel shapes are not essential to practice the invention. Even a nonplanar substrate and conductors may permit the beneficial use of intrinsic capacitance for reducing component count in LED lighting assemblies.

It is envisioned that one intrinsic substrate capacitor per LED is a reasonable approach to populate the circuit board, though this is not absolutely necessary. To extend LED service life, each pad on which an LED is mounted may secondarily operate as a heat sink to draw heat away and permit lower operating temperatures. Further, one or more additional heat sink elements may be attached to the panel to reduce operating temperature.

From a mechanical standpoint, 24″×24″ panels should be practical with this method of supplying the LEDs, as the dropoff in current and voltage feed across that distance along the panel will be minimal, therefore the brightness across the panel will be reasonably uniform unless adjusted by varying capacitor values. Smaller panel dimensions should also be practical, and larger dimensions may not produce uniform light but still have a benefit in some applications.

Electrically, one may add diodes to configure voltage multipliers to accommodate longer

LED series strings, or use larger series capacitance on one end of a long series LED string and connect to a ballast type power oscillator supplying high voltage output.

For an alternate mode of operation, the LEDs may be selected to emit at a wavelength of, for example, 457 nm, of high enough energy to excite a secondary phosphor to make broader spectrum light. This secondary phosphor may be applied in various ways to a lens or light transmissive sheet between the LED panel and the object(s) to be illuminated, whether by painting, spraying, or some other application method.

As is general practice even without a phosphor, one may add a lens or light transmissive sheet to modify the light pattern, whether to act as a diffuser to make light more uniform, or to redirect the light onto a particular area.

From the foregoing, it will be appreciated that the present invention is novel and offers advantages over the prior art. Although a specific embodiment of the invention is described and illustrated above, the invention is not to be limited to the specific forms or arrangements of parts so described and illustrated. For example, differing configurations, sizes, or materials may be used to practice the present invention. The invention is limited by the claims that follow.

What is claimed is:

1. A lighting system, comprising:
an AC power source having a first power output lead and second power output lead;
an insulating substrate;
a first conductive layer having divisions on a first side of the substrate;
a second conductive layer that is electrically contiguous on a second side of the substrate; and
LED pairs comprising:
a first LED and a second LED connected together in antiparallel fashion, each connected pair having first and second conductive leads, arranged whereby said first LED conducts with one electrical polarity across said leads and said second LED conducts with the opposite electrical polarity across said leads;
said first conductive leads of said LED pairs individually connected to separate said divisions of the first conductive layer;
said second conductive leads of said LED pairs wired together in a common tie point;
electrical connection from said first power output lead to said common tie point and from said second power output lead to said second conductive layer;
whereby electrical energy from said AC power source capacitively transfers between said first conductive layer and second conductive layer so as to illuminate the LEDs.

2. A method of alternative use for a ballast designed for use with a fluorescent lamp, the method comprising:
attaching the output of said fluorescent ballast to a set of LEDs and capacitors, in such a way that there is at least one pathway from the output through a capacitor to at least one LED.
